(19) United States
(12) Patent Application Publication
(10) Pub. No.: US 2026/0220029 A1
(43) Pub. Date: Jul. 30, 2026

(54) AGENTIC TEST-DRIVEN CODE GENERATION FOR INSIGHT DISCOVERY

(71) Applicant: Oracle International Corporation, Redwood Shores, CA (US)

(72) Inventors: Moein Owhadi Kareshk, Burnaby (CA); Achraf Zhar, Rabat-Sale-Kenitra (MA); Yasha Pushak, Vancouver (CA); Hesam Fathi Moghadam, Sunnyvale, CA (US); Rhicheek Patra, Zurich (CH); Hassan Chafi, Zurich (CH)

(21) Appl. No.: 19/037,713

(22) Filed: Jan. 27, 2025

(51) Int. Cl. G06F 11/3668; G06F 8/35; G06F 40/30

(52) U.S. Cl. CPC G06F 11/3684; G06F 8/35; G06F 40/30

(57) ABSTRACT

A computer generates and iteratively improves operational logic by incremental refinement of a linguistic prompt to increase its accuracy or by full replacement of the linguistic prompt by a somewhat unrelated linguistic prompt. From a natural language (NL) question about data, a problem summarization large language model (LLM) generates an NL problem summary that specifies multiple semantic requirements. From the semantic requirements, a prover LLM generates a test case that can detect an error in an answer for the NL question. From the semantic requirements, a strategy LLM generates multiple NL solution summaries that each describes a respective distinct solution. An initially best solution summary is iteratively reused to generate and refine solution logic. Excessive iterating may cause switching to a different solution summary for solution logic generation. The generated test cases ensure that logic generation continues until an answer for the NL question is obtained that is provably correct.

### FIELD OF THE INVENTION

For generation and iterative improvement of operational logic, here is strategic prompting that accelerates by minimizing iteration.

### BACKGROUND

Code generation by large language models (LLMs) is an active line of research, and there exists a wide range of models in different capacities, accuracies, and capabilities to intelligently infer new logic. However, LLMs do not have an internal mechanism to ensure that the code they generate addresses the user's request thoroughly, correctly, and safely. State of the art quality control for code generation may be inadequate, in which case inaccuracies in an input prompt or in generated logic may be undetected until deployment and use of incorrect generated logic in a production environment. In those ways and as follows, state of the art learned generation of code may be inaccurate, which is a technologic problem.

Herein, bidirectional encoder representations for transformers (BERT) and generative pretrained transformer (GPT) are interchangeable or equivalent opensource implementations of a general-purpose LLM that is a pretrained deep neural network (DNN) for natural language (NL) processing (NLP). An LLM is a powerful language model that may rely heavily on the structure and patterns of NL to understand and process meaningful text. Diction and phrasing, being the arrangement of words and phrases in a sentence, significantly affect an LLM's accuracy for the following reasons.

An LLM's contextual comprehension may be affected by semantics such as dependency relationships between words in an NL prompt that the LLM accepts as input. The LLM learns how words relate to each other syntactically, which aids in comprehension of the overall meaning of a sentence. For example, recognizing a subject-verb-object structure helps the LLM infer causes and effects. Syntactic information provides structural clues that help the LLM disambiguate words with multiple meanings by considering the context in which a word is used.

The accuracy of an NL prompt may be measured by measuring the accuracy of an inference from the prompt. That is, natural language may be measurably inaccurate. For example, the accuracy of generated NL is measurable.

The following are supervised (i.e. labeled) and unsupervised ways of measuring accuracy of generated NL. With a labeled dataset, it is possible to measure NL accuracy quantitatively with the following various NL metrics, including metrics similar to Factuality that measures how much of the generated NL is relevant (i.e. signal, not noise). The following are automatic ways to measure accuracy of prose.

Bilingual Evaluation Understudy (BLEU) has a scale from 0 to 1 where 0 corresponds to complete inaccuracy and 1 to perfect accuracy. The score is calculated based on the number of matching n-grams (multiword short phrases) using a modified n-gram precision and a brevity penalty to prevent biases.

Recall-Oriented Understudy for Gisting Evaluation (ROUGE) is a set of metrics for comparing the desired output and the reference. It measures the longest matching sequence of words in the two texts.

MPNet measures similarity between two pieces of text as cosine similarity of embedding vectors that represent the text.

The AlignScore metric uses a tuned Robustly Optimized BERT Pretraining Approach (ROBERTa) and a function on the output of the model to output a score between 0 and 1 representing the alignment of two strings of text. This approach is different from the others because it uses an LLM. It uses the embeddings (a compressed representation of the sentence) given as output from the ROBERTa language model.

By the above example accuracy metrics, accuracy of any NL generated herein may be quantified, and this accuracy is a performance measurement of an LLM that generated the NL and a performance measurement of internal operation of a computer that hosts the LLM.

### BRIEF DESCRIPTION OF THE DRAWINGS

In the drawings:

FIG. 1 is a block diagram that depicts an example computer that generates and iteratively improves operational logic by: a) incremental refinement of a linguistic prompt or b) full replacement of the linguistic prompt by a more or less unrelated linguistic prompt;

FIG. 2 is a flow diagram that depicts a computer process that generates correct logic that is executed to generate a correct answer to a user's question;

FIG. 3 is a flow diagram that depicts a computer process that generates and iteratively improves operational logic;

FIG. 4 is a flow diagram that depicts iterative prompting activities that a computer may perform for in-context learning (ICL) to increase accuracy of generated logic;

FIG. 5 is a block diagram that illustrates a computer system upon which an embodiment of the invention may be implemented;

FIG. 6 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

For generation and iterative improvement of operational logic, here is strategic prompting that accelerates by minimizing iteration. To answer a user's question about data, a sequence of more or less similar linguistic prompts is dynamically generated, and this prompt sequence is adaptive in a strategic way that can dynamically re-rank and switch between mutually-exclusive potential ways to obtain the answer. Herein, insights are knowledge, details, patterns, and concerns that are usually hidden in content data for which data scientists use a variety of tools to extract. This approach provides data-driven insight discovery by generating logic in a flexible way, instead of manually or automatically implementing a rigid tool that could be invoked from Large Language Models (LLMs).

This approach summarizes defects to express insights discovered while finding probable root causes of defects. An embodiment is based on an agentic framework where multiple specialized LLMs are used in different stages of a dynamically generated prompt chain. This approach uses task summarization, test driven design (TDD), self-reflection, and self-correction to generate code for insight discovery. This approach avoids manually or automatically creating domain-specific fixed tools for each type (sub-task) of data analysis such as data wrangling, visualization, etc. This approach entails task summarization on the user question and data, exploring potential solutions in natural language (NL), selecting the best potential solution before logic generation, writing automatic tests for the desired code before logic generation, and self-reflection for evaluating and correcting the implementation of a best selected solution.

This approach can be used as a stand-alone agent, a single agent in a multi-agent system, or a flexible tool that is called by another software agent. In an embodiment, a prompt chain processing pipeline has the following enumerated stages 1-5. Numbering of stages 1-5 here is nominal and does not correspond to renumbering of these same stages later herein.

In stage 1, a user's NL question about particular online data is input to task summarization that provides insights about the NL question. The NL question, particular data, and the task summaries output by stage 1 are referred to herein as a problem context. A problem context may be part of the input to some or all subsequent stages. Step 1 aims to comprehend: a) different aspects of the user's question, b) what can make the question technically challenging, c) the features in the data and the semantics of each feature, d) high-level findings about the data, and e) potential problems or inconsistencies in the data.

Stage 2 generates unit tests and an NL description for each test. The goal of step 2 is to infer tests that ensure completeness and correctness of the generated logic, even before identifying any potential solutions to be expressed as inferred NL or inferred logic. Decoupling verification and validation from steps that aim to conceptually solve the user's data analysis problem helps this approach make the general answering goal clear, before focusing on precisely how to reach an answer.

A pool of summaries of possible solutions is created in solution generation stage 3 based on the problem context and NL descriptions of tests (not the tests themselves). The solution summaries are all expressed as NL, so an insightful LLM can freely infer NL solutions without being challenged by precisely how to generate code for them. Stage 3 not only requests the LLM to generate potential solution summaries, but also requests the LLM to expressly explain why each solution works to address the user's question. For increased accuracy to accelerate iterative generation of a correct result, any LLM inference herein may contain self-reflective NL in the LLM's input or output.

From the pool of solution summaries, one is selected in solution selection stage 4 for generating code in code generation stage 5. The target programing language (e.g. JavaScript or standard query language, SQL) is a configuration setting (e.g. LLM hyperparameter) for this approach. When choosing the solution for the first time, an LLM can decide based on the problem context and the list of potential solutions. For each solution summary, the number of times the solution was tried before, and the number of its inoperative (i.e. not merely incorrect) implementations are also taken into account. Keeping track of failures is helpful because some solutions might seem reasonable in an NL format, but LLM might struggle to implement them in the target programming language. This approach can guide an LLM toward choosing a better solution by letting it know if a solution has been tried before, together with the number and type of failures.

In stage 5, the generated logic is evaluated by execution and corrected if required. A solution summary might superficially seem feasible or even straightforward to implement, but implementing that solution might actually be challenging or infeasible. Such a challenge can come from a complication in the solution or a weakness of a code-generative LLM in implementing the solution in the target programming language. Strategic solution selection herein may adaptively switch back and forth between mutually exclusive solution summaries to avoid wasting processing time refining an unworkable solution, and this avoidance accelerates selection of a correct solution for logic generation.

This approach provides test-driven logic generation for insight discovery, including the following innovations. Due to data structure-agnostic design, the user's question can be about a collection of data resources and not just a single dataset. Moreover, these data resources can be heterogeneous and different in terms of type (tabular, unstructured, graph, etc.) and size. This approach can handle such scenarios because this approach generates the code to answer the user's question and, if needed, a self-correction mechanism can handle the complexities of working with multiple data resources.

This approach summarizes the given question as a set of reflection items, both the user's question and the data, before trying to solve the problem to ensure that all the following steps have a clear picture of what the user requests and what data are available. According to test-driven development (TDD), this approach inferentially generates tests before generating any solution logic. This isolation of test generation allows the system to evaluate its output with minimum bias toward the solutions it came up with. Instead of directly generating the solution as logic, this approach first comes up with a set of potential solutions as NL and then generates logic for the best candidate solution. This way, a generative LLM can focus on how to generally solve the problem first, instead of precisely how to implement the solution.

Innovative self-reflection and self-correction is as follows. If the generated logic has syntax problems or cannot pass the generated tests, then this approach tries to correct mistakes by reviewing the generated logic, errors, and failed tests. This also allows the system to use additional filters such as guardrails and static and dynamic code analysis for validation and verification. This approach strategically chooses a best solution based on previous failures. When the system cannot generate valid logic for a solution and aims to choose another solution from the pool of solutions, this approach considers the number of times it tried to generate logic for each of the solutions and their type and cardinality of failures.

Innovations of this approach provide the following advantages. This approach can be employed as a stand-alone agent or embedded into larger software application or set of multiple software agents. This flexibility allows this approach to be used in different use-cases. This approach is model-agnostic and can be used with any underlying LLM even if the LLM is opaque (i.e. black box), and this approach is more or less insensitive to LLM hyperparameters. This approach is language-agnostic and works regardless of the target programming language. This approach verifies and validates the code in terms of both syntax and semantics. Parts of semantic evaluation may be a mix of static or dynamic code analysis or guardrails for security and safety compliance. The logic this approach generates is thoroughly tested to ensure correctness, including addressing the user's question. This increases reliability and accuracy by decreasing defects in generated logic.

### 1.0 Example Computer

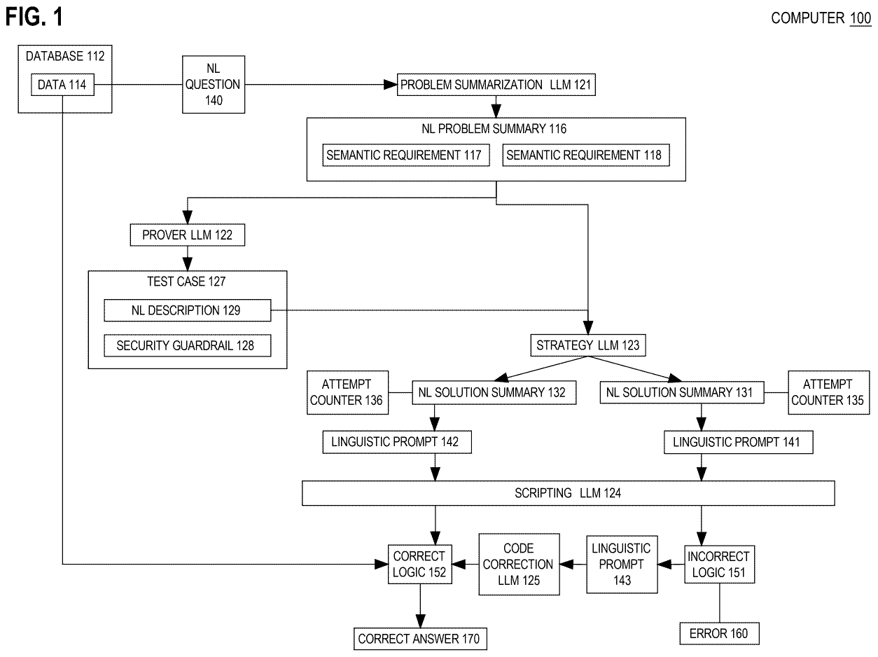

FIG. 1 is a block diagram that depicts an example computer 100 that generates and iteratively improves operational logic by: a) incremental refinement of linguistic prompt 141 to generate more accurate linguistic prompt 143 or b) full replacement of linguistic prompt 141 by more or less unrelated linguistic prompt 142. Computer 100 may be one or more computers such as a rack server such as a blade, a personal computer, a mainframe, or a virtual computer. All of the shown components may be respectively stored and operated in volatile or nonvolatile storage of computer 100.

1.1 Natural Language (NL) Question about Structured Data

In operation, a user is interested in data 114 and asks natural language (NL) question 140 about data 114. In the shown embodiment, data 114 is structured or semi-structured data stored in database 112 that may be a relational database, a graph database, a document database that stores semi-structured documents such as JavaScript object notation (JSON) or extensible markup language (XML), or a key-value store such as a NoSQL database.

In various embodiments not shown that lack database 112, data 114 is stored in a spreadsheet or a datafile. In an embodiment not shown that lacks database 112, data 114 is contained in NL question 140. For example, data 114 may be an unsorted plurality of numbers, and NL question 140 may ask what is the statistical median of those numbers. In an embodiment not shown, distinct parts of data 114 are distributed in multiple datastores such as multiple databases or a mix of databases and datafiles.

NL question 140 is not a database query nor a data query language (DQL) statement such as structured query language (SQL). NL question 140 is prose that is a natural question. NL question 140 cannot be automatically answered without NL processing (NLP). NL question 140 may contain one or more natural sentences. For example in NL question 140, one sentence may be a question, and another sentence may provide qualifications or context that affects interpretation of the question.

### 1.2 Inferentially Generated NL Problem Summary and Multiple Semantic Requirements

NL question 140 is a part or an entirety of a linguistic prompt that problem summarization large language model (LLM) 121 accepts as input, which causes problem summarization LLM 121 to generatively infer NL problem summary 116 that is prose that describes multiple semantic requirements 117-118. For example to discover a statistical median, semantic requirement 117 may be that numbers should be sorted, and semantic requirement 118 may be that, only if there is an even (i.e. not odd) count of the numbers, then the median is an arithmetic mean of exactly two numbers.

Semantic requirements 117-118 are specific to NL question 140. In some embodiments, having database 112 or not, data components 112 and 114 are not accessed for: a) if NL question 140 by itself is not a linguistic prompt, generation of the linguistic prompt that problem summarization LLM 121 accepts and b) operation of problem summarization LLM 121. In an embodiment, NL question 140 does not contain data 114, and NL question 140 is the only input that problem summarization LLM 121 accepts.

The following Table 1 is an example NL problem summa y 116 for an NL question that asks which country is least happy according to World Happiness Report 2024. Each row in Table 1 may be a distinct NL semantic requirement. Table 1 says “row in the DataFrame represents a year's worth”, which means: a) data 114 is the DataFrame, b) problem summarization LLM 121 accesses metadata in the DataFrame, which entails accessing data 114, and c) the actual “row in the DataFrame” is not necessarily (except as follows) accessed by problem summarization LLM 121. Table 1 says “The data includes NaN (Not a Number) values”, which means that problem summarization LLM 121 indeed accesses “Each row in the DataFrame”.

The question asks to identify the “least happy country” without specifying a particular
time frame or criteria for what constitutes “least happy.” This vagueness requires an
interpretation of “least happy” based on the given data attributes.
The data is formatted as a pandas DataFrame, suggesting that the analysis should be
conducted using Python's pandas library, which is well-suited for handling and analyzing this
type of structured data.
Each row in the DataFrame represents a year's worth of data for a country, including
metrics such as “Life Ladder” (likely a measure of happiness or well-being), “Log GDP per
capita” (a measure of economic performance), “Social support,” “Healthy life expectancy at
birth,” “Freedom to make life choices,” “Generosity,” “Perceptions of corruption,” “Positive
affect,” and “Negative affect.” The presence of multiple years per country implies that the
analysis could either look for the overall least happy country across all years or the least happy
country within a specific year.
“Life Ladder” could be the primary metric for determining happiness, as it directly
implies a measure of quality of life or happiness level. This assumption is made based on the
naming convention and the nature of the question. Therefore, identifying the least happy
country would likely involve analyzing the “Life Ladder” scores.
The data includes NaN (Not a Number) values, particularly for “Log GDP per capita”
and “Generosity” in the last two entries for Afghanistan, which indicates missing or undefined
data for those years. This introduces complexity in analyzing or comparing these values across
different countries or years and may require handling missing data through methods like
imputation or exclusion of incomplete records.
The final years listed, particularly for Afghanistan (2022, 2023), show a drastic
decrease in the “Life Ladder” score, suggesting a significant decline in happiness or well-
being. This temporal dimension highlights the need to consider when the analysis is done, as
the “least happy” status could change over time.
Not all countries are represented equally with data for every year within the provided
snippet, and not all common indicators might be fully present or consistent across all entries,
suggesting variability in data collection or availability. This variability must be taken into
account when performing cross-sectional or longitudinal analyses.
The question implicitly asks for a singular answer (the least happy country), but the
data structure and the existence of multiple years worth of data per country suggest that there
could be different answers depending on whether one takes an average of happiness scores
over time or considers only the most recent data.
The inclusion of several psychological and economic indicators alongside the “Life
Ladder” score suggests a comprehensive approach to measuring happiness, incorporating
various factors that could influence one's perception of well-being. However, the question's
focus on the “least happy country” simplifies the task to primarily evaluating the given “Life
Ladder” scores while acknowledging the complexity and multifaceted nature of happiness.

### 1.3 Inferentially Generated Test Cases for Test Driven Design (TDD)

Each of LLMs 122-123 receives a respective distinct linguistic prompt (not shown) that contains NL problem summary 116 or at least semantic requirements 117-118. In an embodiment, prover LLM 122 inferentially generates test case 127 before strategy LLM 123 operates. Test case 127 is an executable test, such as a test script or a unit test, that, when later executed, would verify whether or not answer 170 is correct even though correct answer 170 is undetermined when test case 127 is generated as discussed elsewhere herein.

Test case 127 is directly specific to one, some, or all of semantic requirements 117-118 and indirectly specific to NL question 140. In an embodiment, there is a one-to-one correspondence between one semantic requirement, one test case, and one test description. For example, test case 127 contains NL description 129 that is prose that describes test case 127. NL description 129 may mention or discuss semantic requirements 117-118. In a test driven design (TDD) embodiment, test case 127 executes: a) at least once before strategy LLM 123 operates to verify that test case 127 fails and b) at least once again after generated logic 151 or 152 executes to verify a successful logic execution after zero or more failed logic executions.

The following Tables 2-3 each contains a distinct example test case. Both test cases are inferentially generated from the same example NL problem summary 116 shown above in Table 1. Here is Table 2.

| Item | Value |
|---|---|
| Structure | Input is provided as a dictionary with a ‘data’ key, containing a list of |
| Input | lists that represent country data per year. |
| Structure | Output is a string representing the country name with the lowest ‘Life |
| Output | Ladder’ score. |
| Input | {‘data’: [[‘Zimbabwe’, 2019, 2.693523, 7.950753, 0.716004, |
| | 56.200001, 0.375038, −0.009072, 0.830652, 0.710119, 0.211726], |
| | [‘Yemen’, 2019, 3.380646, 7.578745, 0.789422, 56.700001, 0.552726, |
| | 0.057249, 0.798055, 0.308151, 0.244175], |
| | [‘Venezuela’, 2019, 5.053707, 8.977794, 0.890408, 66.505997, |
| | 0.610855, −0.045272, 0.837038, 0.595783, 0.239851]]} |
| Output | ‘Zimbabwe’ |
| Explanation | Among the given countries for the year 2019, Zimbabwe has the |
| | lowest ‘Life Ladder’ score at 2.693523. The question was to identify |
| | the least happy country based on available data, and by inspecting the |
| | ‘Life Ladder’ column, Zimbabwe is identified as the least happy. This |
| | outcome is reached by comparing the ‘Life Ladder’ scores of all |
| | provided entries and identifying the lowest among them, with |
| | Zimbabwe being the clear choice for 2019 from this subset. |

The following is Table 3.

| Item | Value |
|---|---|
| Structure | Input is a dictionary with ‘data’ key, containing an empty list which |
| Input | represents no data available. |
| Structure | Output is an empty string, indicating no country could be identified as |
| Output | the least happy. |
| Input | {‘data’: [ ]} |
| Output | ‘’ |
| Explanation | With no data provided, it's impossible to determine the least happy |
| | country. This case handles empty inputs by outputting an empty string, |
| | aligning with the guideline that empty inputs are treated simply and |
| | without generating messages or information about missing data. |

### 1.4 Inferentially Generated NL Solution Summaries are Mutually Exclusive Solution Design Alternatives

Strategy LLM 123 generates multiple NL solution summaries 131-132, each of which is prose that describes a respective technical solution that, if implemented, would: a) generate a correct or incorrect answer to NL question 140 or b) fail to build or fail to execute. In one example, each of NL solution summaries 131-132 describes a respective distinct technical strategy. In another example, NL solution summaries 131-132 describe a respective distinct technical tactic for implementing a same technical strategy.

Either of components 100 and 123 may initially rank or score NL solution summaries 131-132 before any of linguistic prompts 141-142 are generated, and that ranking or scoring reflects how respectively likely to be correct is each of NL solution summaries 131-132. In other words, that ranking or scoring estimates how respectively accurate is each of NL solution summaries 131-132. As discussed later herein, attempt counters 135-136 can be used to dynamically adjust, based on failed logic executions, the relative ranking of NL solution summaries 131-132. For example as discussed later herein, computer 100 may initially decide that NL solution summary 131 is best but, after repeated logic execution failures based on NL solution summary 131, may instead decide that NL solution summary 132 is better.

With NL solution summary 131 initially selected as best, NL solution summary 131 may be used as linguistic prompt 141 or may be part of a linguistic prompt 141 that computer 100 generates. All unshown and shown linguistic prompts 141-143 are or contain NL that may, for example, be tokenized into a sequence of lexical tokens (e.g. natural words). Any linguistic prompt herein, whether solely or partially composed of NL, may be tokenized. Generative NLP is referred to herein as NL generation (NLG). LLMs 121-125 each performs respective one or a few NLG functions that each is a specialization of a respective general kind of NLG function.

Herein, a prosaic function is a general NLG function that primarily or exclusively generates prose (i.e. NL, e.g. a natural sentence or natural paragraph). A prosaic function may be referred to herein as an NL-to-NL function. LLMs 121 and 123 each performs a distinct respective prosaic function as discussed herein.

### 1.5 Inferentially Generated Solution Logic

LLMs 122 and 124-125 perform a respective NLG that entails code (i.e. logic) generation as follows. Scripting LLM 124 accepts linguistic prompt 141 as input, which causes scripting LLM 124 to, in the shown example, inferentially generate incorrect logic 151. Incorrect logic 151 causes error 160 either during building (e.g. compiling) or during execution. For example, incorrect logic 151 may fully execute but yield an incorrect result or no result.

Error 160 represents any failure of incorrect logic 151 to generate correct answer 170, even if incorrect logic 151 fails to build or fully execute. In one example, error 160 is undetected until test case 127 executes and detects error 160. In various examples, error 160 is an unsatisfied (i.e. violated) precondition, postcondition, or invariant of test case 127.

In many examples, a postcondition entails inspection of correct answer 170. In an embodiment that entails a statistical median as discussed earlier herein, test case 127 may specify a postcondition that requires the plurality of numbers (i.e. data 114) expressly contains the answer (i.e. the value of the median) if there is an odd count of numbers, and test case 127, including a specification of this postcondition, may be inferentially generated without accessing data components 112 and 114 and without determining what is correct answer 170. In an embodiment, problem summarization LLM 121 accesses data 114, but prover LLM 122 does not.

In an example discussed later herein, failure of a precondition causes iterative refinement (i.e. improved regeneration or replacement) of test case 127 before strategy LLM 123 operates. In a TDD embodiment, version(s) of test case 127 are the only logic generated by computer 100 until execution of test case 127 satisfies all preconditions and fails to satisfy at least one postcondition or invariant. That is, strategy LLM 123 does not operate until execution of test case 127 fails a postcondition or invariant.

In an embodiment, test case 127 contains security guardrail 128 that is a postcondition or invariant. Execution of test case 127 causes enforcement (i.e. applying) of security guardrail 128. For example, security guardrail 128 may be an invariant that variously forbids inferentially generated logic 151 or 152 containing: a) a (i.e. hardcoded) clear text password or b) if database 112 is present, a database statement that is data control language (DCL), data definition language (DDL), or data manipulation language (DML). For example, data query language (DQL) may be the only structured query language (SQL) that security guardrail 128 permits. Computer 100 does not execute inferentially generated logic unless that logic satisfies security guardrail 128.

### 1.6 Multiple Failed Generative Attempts During Incremental Refinement

In an embodiment, error 160 is text such as an error message or one or more lines of console output. For example, error 160 may be text generated by any of: a source logic compiler, build automation, deployment automation such as Jenkins as discussed later herein, or by the execution of either of executable components 127 and 151. In one example, error 160 comprises a whole or partial stack trace of an exception caused by executing incorrect logic 151. In another example, incorrect logic 151 fully executes, and error 160 is a warning, by execution of test case 127, that correct answer 170 was not generated, even if correct answer 170 is uncertain during full execution of test case 127. For example, test case 127 may detect that a negative number is wrong even if which positive number is correct answer 170 is unknown to test case 127.

Computer 100 has two adaptive modes for remedying error 160 caused by incorrect logic 151. These two adaptive modes are temporally mutually exclusive. For example, computer 100 may switch back and forth between the two adaptive modes, but should not simultaneously use both modes. For example as follows, an outer control-flow loop may perform a solution selection mode, and an inner control-flow loop, nested in the outer control-flow loop, may perform a solution refinement mode.

Solution refinement entails continued use of NL solution summary 131 even though NL solution summary 131 caused generation of incorrect components 151 and 160. Solution refinement entails generation of linguistic prompt 143 that, unlike linguistic prompt 141, contains error feedback including either or both of incorrect components 151 and 160.

Code correction LLM 125 accepts linguistic prompt 143 as input, which causes code correction LLM 125 to inferentially generate an incremental refinement of incorrect logic 151. Refined logic inferentially generated by code correction LLM 125 may be correct logic 152 as shown or may instead be another incorrect logic that may cause same error 160 or a different error.

In an example not shown, code correction LLM 125 accepts a linguistic prompt that contains incorrect logic that code correction LLM 125 already generated. That is, code correction LLM 125 may be repeatedly invoked for same NL solution summary 131.

Attempt counters 135-136 initially are zero. Each time NL solution summary 131 is (re-)used to generate a new logic, attempt counter 135 is incremented by one. It does not matter which exactly one of LLMs 124-125 is used during a solution attempt. For example, attempt counter 135 may be incremented when linguistic prompt 141 is generated and incremented again when linguistic prompt 143 is generated.

### 1.7 Execution of Correct Logic Provides Correct Answer

Solution refinement by code correction LLM 125 may repeat until a threshold count of refinement attempts. In an embodiment, if attempt counter 135 reaches any multiple of, for example, five then computer 100 may switch adaptive modes from solution refinement mode to solution selection mode. NL solution summary 132 may be selected if attempt counter 136 has the lowest count of many NL solution summaries that originally were generated by strategy LLM 123. A tie between multiple NL solution summaries for lowest attempt counter may be resolved by selecting an NL solution summary having a better original rank or score as discussed earlier herein.

Although linguistic prompt 142 is shown as potentially causing generation of correct logic 152, in a scenario not shown, linguistic prompt 142 instead causes generation of incorrect logic, and code correction LLM 125 may be (e.g. repeatedly) invoked based on NL solution summary 132. All of linguistic prompts 141-143 are distinct even though any of linguistic prompts 141-143 might cause an LLM to generate correct logic 152 that generates correct answer 170. Components 152 and 170 are not considered correct until execution of all test cases agree (i.e. pass) that answer 170 is correct.

Execution of incorrect logic 151 may or may not actually access data 114. However, execution of correct logic 152 necessarily accesses data 114 because correct answer 170 cannot be obtained without reading some or all of data 114. When test case 127 confirms answer 170 is correct, answer 170 is returned to the user such as by display of correct answer 170 on a screen, by text-to-speech in which correct answer 170 is spoken audio, or by inclusion of correct answer 170 in a document such as an email.

The following is an example correct logic 152 for the example problem in above Table 1.

```
import pandas as pd
# Function to convert input data into DataFrame
def convert_to_dataframe(input_data):
  return pd.DataFrame(input_data[‘data’])
# Function to identify the least happy country
def find_least_happy_country(df):
  if df.empty:
    return { }
  else:
    idx_min = df[‘Life Ladder’].idxmin( )
    return df.loc[idx_min, ‘Country name’]
if _{——}name_{——} == “_{——}main_{——}”:
  lines = [ ]
  while True:
    try:
      line = input( ). # externally overloaded
      if line:
        lines.append(line)
      else:
        break
    except EOFError:
      break
  input_data = eval(‘\n’.join(lines))
  df = convert_to_dataframe(input_data)
  result = find_least_happy_country(df)
  if result:
    print(result)
  else:
    print(result) # This will print an empty dictionary if there's no
input data
```

Correct answer 170 may be a scalar value or a (e.g. tabular) plurality of values, and may include NL generated by correct logic 152, not inferentially, but instead by a hard-coded template in correct logic 152. For example, correct logic 152 may contain a formatted print statement such as “The most full shopping cart contains #(tally) items”, where tally is a placeholder that is replaced with a number calculated by correct logic 152 based on data 114. In an embodiment, correct answer 170 may be graphical (i.e. visual) such as a histogram, a pie chart, or a scatter plot, and test case 127 may, for example, perform some graphical verification such as image analysis.

### 2.0 Example Code-Generative Feedback Loop

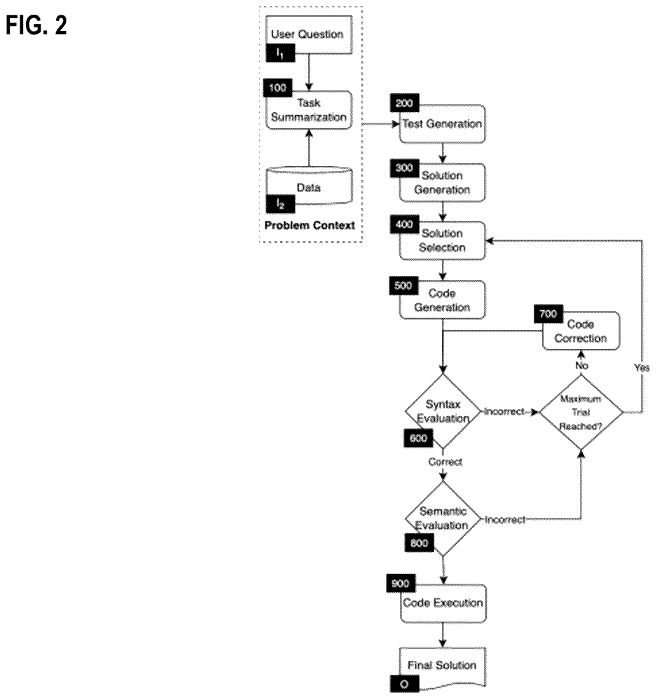

In this exemplary embodiment, FIGS. 1-2 are related as follows. Input user question I1 is NL question 140. Input data I2 is data 114. Output final solution O is correct answer 170. Task summarization step 100 in FIG. 2 is not computer 100 in FIG. 1.

FIG. 2 is a flow diagram that depicts an example process that computer 100 may perform to generate correct logic 152 and generate output final solution O. This exemplary embodiment uses task summarization, test driven design (TDD), self-reflection, and self-correction to generate code for insight discovery instead of manually or automatically creating domain-specific fixed tools for each type (sub-task) of data analysis such as data wrangling, visualization, etc. This exemplary embodiment can be used as a stand-alone agent, as a single agent in a multi-agent system, or as a flexible tool that is called by another software agent.

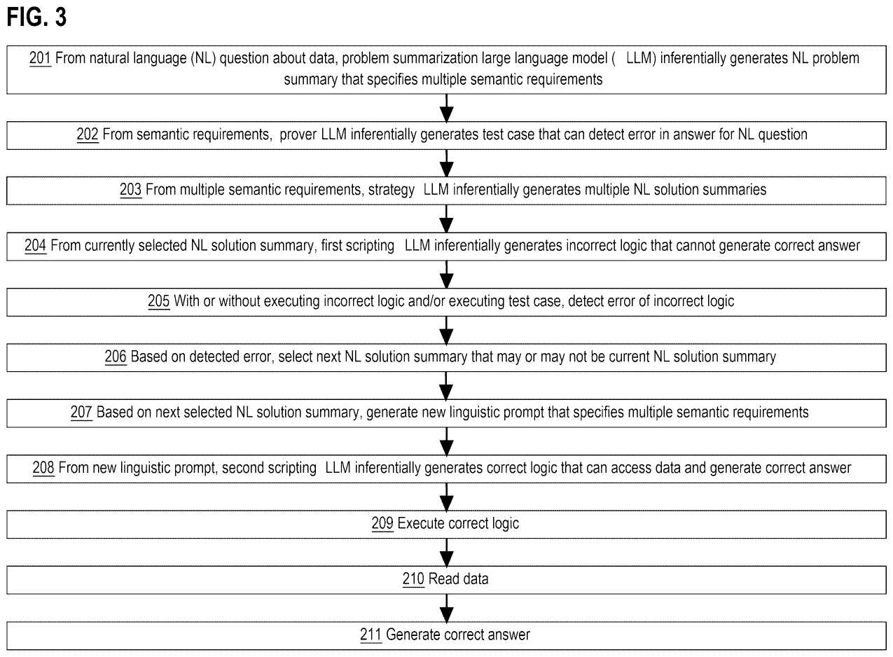

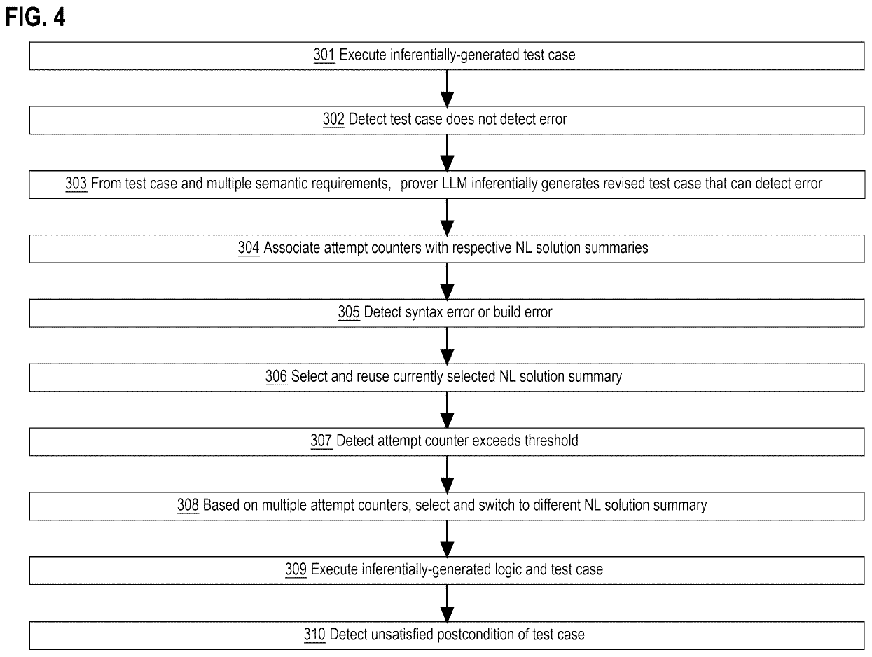

The following discussion of FIG. 2 provides an overview of control flow of a duty cycle of computer 100 in which one NL question is correctly answered. FIG. 2 demonstrates functional relationships between steps, including dataflow. General behaviors in the following compact discussion of FIG. 2 are further discussed later for FIGS. 3-4.

User question I1 and data I2 are the inputs to task summarization step 100 that problem summarization large language model (LLM) 121 performs as discussed later herein. User question, data, and the output of the task summarization step are called the problem context. The problem context is the input of all the subsequent stages. Step 100 aims to understand different aspects of the user's question, what can make the question challenging, the features in the data and the semantics of each of them, high-level findings about the data, and potential problem or inconsistencies in the data, etc.

Prover LLM 122 performs test generation step 200 that generates multiple unit tests and an NL description for each test, including test components 127 and 129 as discussed later herein. The goal of step 200 is to infer tests that ensure completeness and correctness of logic that will be generated. Step 200 occurs before identifying any potential solutions in natural language (NL) or code. This decouples verification and validation from problem solving to maximize accuracy.

A pool of possible solutions, including NL solution summaries 131-132, is inferentially created by strategy LLM 123 in solution generation step 300 based on the problem context and the NL descriptions of tests (not the tests themselves). In an embodiment, strategy LLM 123 accepts a linguistic prompt that contains a compound request that: a) asks strategy LLM 123 to generate multiple potential solutions and b) asks strategy LLM 123 to generate prose that explains why each solution should work for addressing input user question I1.

From the pool of NL solution summaries 131-132, a dynamically best one solution summary is selected in solution selection step 400 for inferentially generating code in code generation step 500 by scripting LLM 124. In an embodiment, the target programing language for logics 151-152 is a hyperparameter for code generator LLMs 124-125. For multiple solution selections in sequence, the number of times each solution is tried before, and the number of its failed implementations are tracked. Keeping track of failures is helpful because some solutions might seem reasonable in the NL format, but code correction LLM 125 might struggle to implement them in the target programming language, which is compensated for as follows.

In an embodiment, step 600 does not perform a static (i.e. analytic) detection but, instead, performs an empirical detection of whether a current one of generated logics 151-152 is ready to execute. The shown horizontal arrow from step 600 indicates that the current generated logic is incorrect due to inability to execute to completion. Empirical detection step 600 occurs during execution of the current generated logic. Syntax evaluation step 600 detects whether the current generated logic failed to fully execute due to a syntax error in the current generated logic.

Syntax evaluation step 600 also detects whether execution of the current generated logic failed due to a semantic error in the current generated logic, such as a timeout due to an infinite loop or a thrown exception due to division by zero or an array offset out of bounds. In addition to attempt counters 135-136, computer 100 may track occurrences or counts of particular kinds or modes of failures of many incorrect logics generated for input user question I1. Step 600 does not verify presence nor correctness of the answer generated by executing the generated logic.

Discussed later herein is a feedback loop by repetition of steps 600 and 700 until logic with correct syntax is created or attempt counter 135 or 136 of the current NL solution summary exceeds a threshold for a maximum number of trials, which causes switching from solution refinement to solution selection, which are two adaptive modes discussed elsewhere herein. A maximum number of trials to fix a logic of one solution is a hyperparameter of the system. Code correction step 700 receives related information about the generated logic such as errors and warnings. If the maximum number of trials is reached, computer 100 chooses another solution summary in solution selection step 400.

Only if the generated logic fully executed, the generated logic is then evaluated for correctness in semantic evaluation step 800 that executes the test cases generated by step 200. Only if all test cases pass (i.e. successfully execute), then code execution step 900 executes correct logic 152 that generates output final solution O.

The following Table 4 provides example configurability and dataflow between the steps of FIG. 2. Most of these steps are performed by LLMs shown in FIG. 1 and, in that way, Table 4 provides example configurability and dataflow between LLMs of FIG. 1. In Table 4, final means correct.

| Step in FIG. 2 | Input | Output | Hyper-Parameters |
|---|---|---|---|
| Task | User Question | Summary of | LLM configurations |
| Summarization | Data | the user's | (temperature, etc.) |
| (100) | | question and | Maximum number of |
| | | the data | summary items |
| Test | Problem | Set of tests | LLM configurations |
| Generation | context (user's | | (temperature, etc.) |
| (200) | question, data, | | Maximum number of |
| | and task | | tests |
| | summary) | | Programming language |
| Solution | Problem | Set of potential | LLM configurations |
| Generation | context (user's | solutions | (temperature, etc.) |
| (300) | question, data, | | Maximum number of |
| | and task | | solutions |
| | summary) | | |
| | Description of | | |
| | tests | | |
| Solution | Problem | The best | No hyper-parameter |
| Selection | context (user's | potential | |
| (400) | question, data, | solution to | |
| | and task | generate code | |
| | summary) | for | |
| | Set of potential | | |
| | solutions + | | |
| | summary of | | |
| | their failure | | |
| | history (if | | |
| | available) | | |
| Code | Problem | The | LLM configurations |
| Generation | context (user's | implementation | (temperature, etc.) |
| (500) | question, data, | of the given | Programming language |
| | and task | solution | |
| | summary) | | |
| | Set of tests | | |
| | The best | | |
| | potential | | |
| | solution to | | |
| | generate code | | |
| | for | | |
| Syntax | Problem | Branch, based | Runtime to execute the |
| Evaluation | context (user's | on the input | code |
| (600) | question, data, | implementation | Maximum number of |
| | and task | | trials for each solution |
| | summary) | | |
| | The | | |
| | implementation | | |
| | of the given | | |
| | solution | | |
| Code | Problem | The corrected | LLM configurations |
| Correction | context (user's | implementation | (temperature, etc.) |
| (700) | question, data, | of the input | |
| | and task | solutions | |
| | summary) | | |
| | The | | |
| | implementation | | |
| | of the given | | |
| | solution | | |
| | The output | | |
| | (errors, etc.) of | | |
| | Syntax | | |
| | Evaluation | | |
| | (600) | | |
| Semantic | Problem | Final code to | LLM configurations |
| Evaluation | context (user's | execute | (temperature, etc.) |
| (800) | question, data, | | |
| | and task | | |
| | summary) | | |
| | The | | |
| | implementation | | |
| | of the given | | |
| | solution | | |
| Code | Data (12) | Final Solution | Runtime to execute the |
| Execution | Final code to | | code |
| (900) | execute | | |

### 3.0 Example Code Generative Process

FIG. 3 is a flow diagram that depicts an example process that computer 100 may perform to generate correct components 152 and 170 by: a) incremental refinement of linguistic prompt 141 to generate more accurate linguistic prompt 143 or b) full replacement of linguistic prompt 141 by more or less unrelated linguistic prompt 142.

From natural language (NL) question 140 about data 114 in step 201, problem summarization large language model (LLM) 121 inferentially generates NL problem summary 116 that specifies a variable amount of multiple semantic requirements 117-118 as discussed earlier herein. Before the process of FIG. 2, problem summarization LLM 121 already was pretrained or finetuned to perform step 201 as a training task. LLM training tasks herein may be supervised or self-supervised. Training inaccuracy is compensated for herein by iterative prompting to increase accuracy without further training as discussed for FIG. 3 later herein.

From multiple semantic requirements 117-118 in step 202, prover LLM 122 inferentially generates test case 127 that can detect error 160 for NL question 140, such as in incorrect answer that is not correct answer 170, even if correct answer 170 is undetermined until after step 202. Before the process of FIG. 2, prover LLM 122 already was pretrained or finetuned to perform step 202 as a training task. As discussed herein, each of LLMs 121-125 was already trained with its own distinct training task. In various embodiments, some or all of five LLMs 121-125 are consolidated into fewer or only one LLM. In an embodiment, two LLMs 121-122 are a same single LLM that already trained with two distinct training tasks, even though problem summarization LLM 121 is prosaic, as defined earlier herein, and prover LLM 122 is code generative instead of prosaic.

From multiple semantic requirements 117-118 in step 203, strategy LLM 123 inferentially generates multiple NL solution summaries 131-132. In this example, computer 100 initially (i.e. provisionally) selects NL solution summary 131 as a best (i.e. most promising, most likely to cause generation of correct components 152 and 170) solution summary. Initial selection heuristics may include selecting the NL solution summary that: a) contains the most words, b) contains the most linguistic terms (i.e. distinct noun phrases) that occur in at least one of semantic requirements 117-118, or c) has the fewest of semantic requirements 117-118 that contain none of the terms in the solution summary. Herein, a noun phrase is a noun or a multiword phrase that contains a noun and adjective(s) of the noun.

From currently selected NL solution summary 131 that is contained in linguistic prompt 141 in step 204, scripting LLM 124 inferentially generates incorrect logic 151 that cannot generate correct answer 170 as discussed earlier herein. With or without executing incorrect logic 151 and/or executing test case 127, step 205 detects error 160 as discussed earlier herein.

Responsive to detected error 160, step 206 selects a next one of NL solution summaries 131-132, which may or may not be current NL solution summary 131. As discussed elsewhere herein for FIGS. 1 and 3, computer 100 has two adaptive modes for remedying error 160, and these are a solution selection mode and a solution refinement mode. As discussed elsewhere herein, step 206 decides which one adaptive mode to use and selects the next NL solution summary based on which adaptive mode is selected. If solution refinement is chosen, the next and previous NL solution summaries both are same NL solution summary 131. If solution selection is instead chosen, the next NL solution summary is NL solution summary 132.

If step 206 chose solution refinement, then step 207 generates new linguistic prompt 143 based on NL solution summary 131. If step 206 chose solution selection, then behavior of step 207 depends on whether NL solution summary 132 was already used to generate linguistic prompt 142, even though linguistic prompt 142 would since have been discarded as discussed later herein. If step 206 chose solution selection and NL solution summary 132 was not already used (i.e. never before attempted logic generation), then step 207 generates new linguistic prompt 142.

If step 206 chose solution selection and selected next NL solution summary 132 already was (i.e. unsuccessfully) used before NL solution summary 131, then step 207 generates a new linguistic prompt 143 based on NL solution summary 132. In this case in step 206, solution selection switched from NL solution summary 131 to NL solution summary 132 but, because NL solution summary 132 was already used, earlier solution refinement with code correction LLM 125 resumes for NL solution summary 132 in step 207. As discussed earlier herein, linguistic prompt 143 contains incorrect logic that, in this case, is the latest (i.e. incorrect) logic earlier generated for NL solution summary 132. Latest generated incorrect components 151 and 160 for each of NL solution summaries 131-132 should be retained for inclusion in linguistic prompt 143 when the solution summary is deselected and then later reselected (i.e. revisited).

Linguistic prompts 141-142 can be generated from a same prompt template that contains placeholders into which some or all of texts 116-118 can be respectively inserted. NL problem summary 116 contains a variable amount of semantic requirements 117-118, which prompt template(s) should accommodate. Linguistic prompts 141-142 may also contain NL question 140.

Linguistic prompts 141 and 143 should be generated from distinct respective prompt templates because linguistic prompts 141 and 143 have different respective roles in different respective stages of the prompt chain. For example, template placeholders for inserting incorrect components 151 and 160 may be used to generate linguistic prompt 143 but not for linguistic prompt 141. Regardless of whether step 207 generates linguistic prompt 142 or 143, the prompt generated by step 207 specifies (i.e. contains specifications of) multiple semantic requirements 117-118.

From the new linguistic prompt generated by step 207, a second scripting LLM inferentially generates, in this example, correct logic 152 that can read data 114 and can generate correct answer 170. If step 206 chose solution selection of an NL solution summary that was not already used, then same scripting LLM 124 is used for both steps 204 and 208. If step 206 chose solution selection of an NL solution summary that was already used or chose solution refinement, then step 208 instead uses code correction LLM 125. In an embodiment, code generative LLMs 124-125 are a same single scripting LLM.

In this example where logic 152 is correct, step 209 executes correct logic 152, which may or may not entail compiling and/or building (e.g. deployment packaging). In a minimal example, correct logic 152 is JavaScript or SQL that has no compile/build phase, and correct logic 152 can be more or less directly executed as is. In a data center or cloud example, step 209 uses a continuous delivery tool such as open source Jenkins to remotely deploy and execute correct logic 152.

Steps 210-211 are sub-steps of execution step 209. In step 210, correct logic 152 reads some or all of data 114. In step 211, correct logic 152 generates correct answer 170. Answer 170 is not accepted as correct until step 211 lastly executes and passes (i.e. succeeds) all generated test cases, after which correct answer 170 is provided to the user. In an embodiment, execution of test case 127 causes execution of logic 151 or 152, in which case test case 127 performs step 209. For example for safety, test case 127 can avoid executing incorrect logic 151 if security guardrail 128 is unsatisfied.

### 4.0 Example Code Generative Activities

FIG. 4 is a flow diagram that depicts example iterative prompting activities that computer 100 may perform for in-context learning (ICL) to increase accuracy of generated or operated components 100, 122, 125, 127-128, 152, and 170. Without retraining, iterative prompting entails repeated attempts to adjust a linguistic prompt to more or less monotonically increase accuracy of generative natural language (NL) processing (NLP).

As discussed earlier herein, computer 100 has two adaptive modes for remedying error 160, and these are a solution selection mode and a solution refinement mode. Herein, solution refinement entails a form of ICL referred to herein as iterative prompting as discussed later for step 306. However as follows, solution refinement is not the only use of iterative prompting by computer 100. As follows, iterative prompting generates distinct improved versions of test case 127 until test case 127 can detect the absence of correct answer 170, even if correct answer 170 is undetermined until after the final version of test case 127 is generated.

Before any answer is generated, execution of test case 127 should occur in step 301 and should fail (i.e. not pass) and, if step 302 detects test case 127 (i.e. wrongly) passes before any answer is generated, then test case 127 should be iteratively revised until such failure occurs. From test case 127 and multiple semantic requirements 117-118, during iterative prompting in step 303, prover large language model (LLM) 122 inferentially generates revised test case 127 that can detect absence of correct answer 170.

Step 304 inferentially generates NL solution summaries 131-132 and associates them with respective attempt counters 135-136 that are initialized to zero. In this example, incorrect logic 151 is generated from initially selected NL solution summary 131 in step 305. Step 305 detects that incorrect logic 151 causes error 160 that is a syntax error or build error, and these are errors that prevent initiating execution of incorrect logic 151.

As discussed earlier herein, computer 100 has two adaptive modes for remedying error 160, and these are a solution selection mode and a solution refinement mode. Solution refinement entails iterative prompting and, in this example, step 306 chooses solution refinement. In that case, step 306 selects and reuses currently selected NL solution summary 131 to generate a sequence of improved versions of linguistic prompt 143. Step 306 increments attempt counter 135 each time a next version of linguistic prompt 143 is generated.

However in this example, all of the versions of linguistic prompt 143 generated by step 306 cause generation of incorrect logic, and step 307 detects attempt counter 135 exceeds a threshold, which causes computer 100 to switch from solution refinement mode to solution selection mode. Based on multiple attempt counters, step 308 selects and switches to NL solution summary 132 because next attempt counter 136 is less than current attempt counter 135.

Step 309 generates linguistic prompt 142 that, in this example, causes scripting LLM 124 to inferentially generate incorrect logic. Step 309 executes that incorrect logic and executes test case 127, and step 310 detects an unsatisfied (i.e. failed) postcondition of test case 127. Steps 309-310 may repeat for iterative prompting with code correction LLM 125 to cause repeated attempts of logic generation until, in one scenario, code correction LLM 125 eventually inferentially generates correct logic 152 from NL solution summary 132.

In another scenario, iterative prompting by step 309 causes attempt counter 142 to exceed the threshold without generating correct logic 152. In that case, solution selection mode recurs and may, for example, switch back to NL solution summary 131 that was earlier tried in step 305. Thus, computer 100 may switch back and forth between NL solution summaries 131-132 until correct logic 152 is generated.

When solution selection causes revisiting earlier-tried NL solution summary 131, linguistic prompt 141 is not used (i.e. neither reused nor regenerated). Instead, revisitation of earlier-tried NL solution summary 131 entails resuming solution refinement mode for NL solution summary 131 using code correction LLM 125. That is, each of NL solution summaries 131-132 is generated exactly once for repeated reuse. Each of linguistic prompts 141-142 is generated and used at most once and never reused. For generating correct logic 152, linguistic prompt 143 is the only prompt that can be refined. Technically herein, some prompts can be refined and other prompts cannot, but no version of a prompt can be reused. For example to reclaim (i.e. conserve) space (i.e. random access memory, RAM), an embodiment may discard each prompt immediately after use, except for linguistic prompt 143 for revisitation as discussed earlier herein.

### 5.0 Database System Overview

A database management system (DBMS) manages one or more databases. A DBMS may comprise one or more database servers. A database comprises database data and a database dictionary that are stored on a persistent memory mechanism, such as a set of hard disks. Database data may be stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology.

Users interact with a database server of a DBMS by submitting to the database server commands that cause the database server to perform operations on data stored in a database. A user may be one or more applications running on a client computer that interact with a database server. Multiple users may also be referred to herein collectively as a user.

A database command may be in the form of a database statement that conforms to a database language. A database language for expressing the database commands is the Structured Query Language (SQL). There are many different versions of SQL, some versions are standard and some proprietary, and there are a variety of extensions. Data definition language (“DDL”) commands are issued to a database server to create or configure database objects, such as tables, views, or complex data types. SQL/XML is a common extension of SQL used when manipulating XML data in an object-relational database.

A multi-node database management system is made up of interconnected nodes that share access to the same database or databases. Typically, the nodes are interconnected via a network and share access, in varying degrees, to shared storage, e.g. shared access to a set of disk drives and data blocks stored thereon. The varying degrees of shared access between the nodes may include shared nothing, shared everything, exclusive access to database partitions by node, or some combination thereof. The nodes in a multi-node database system may be in the form of a group of computers (e.g. work stations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance”. A database server may comprise multiple database instances, some or all of which are running on separate computers, including separate server blades.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

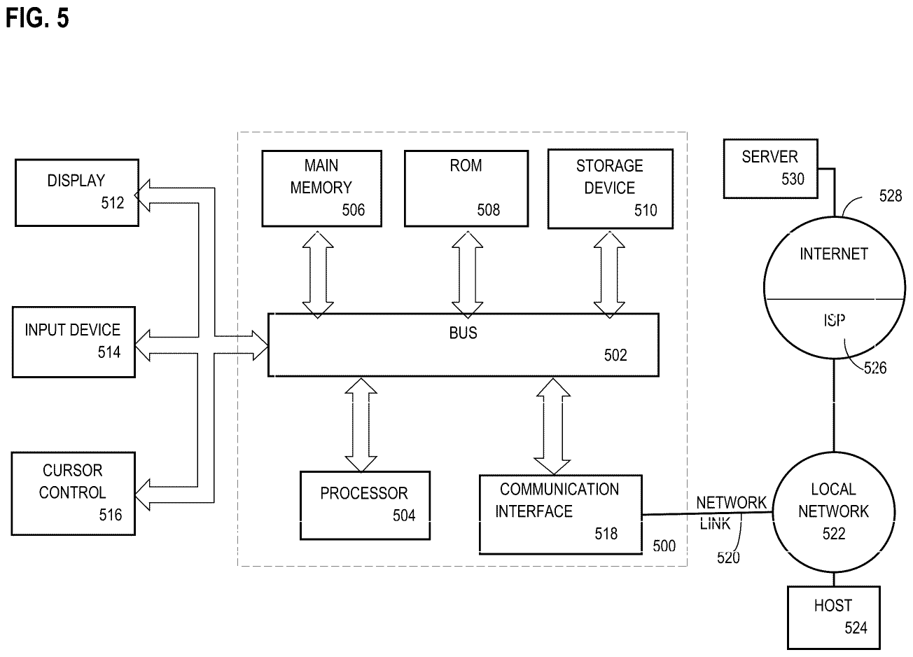

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

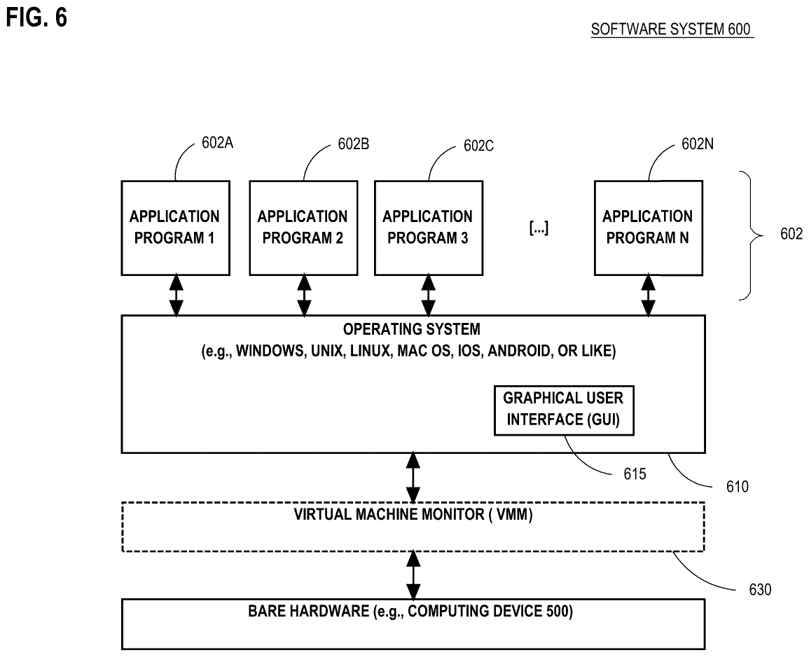

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
inferentially generating, from a natural language (NL) question about a data, by a problem summarization large language model (LLM), an NL problem summary that specifies a plurality of semantic requirements;
inferentially generating, from the plurality of semantic requirements, by a prover LLM, a test case that can detect an error in an answer for the NL question;
inferentially generating, from the plurality of semantic requirements, by a strategy LLM, a plurality of NL solution summaries, wherein each NL solution summary describes a respective distinct solution of a plurality of mutually-exclusive solutions for the NL question;
inferentially generating, from a first selected NL solution summary of the plurality of NL solution summaries, by a first scripting LLM, an incorrect logic that cannot generate a correct answer;
detecting an error of the incorrect logic, wherein said detecting can comprise executing the incorrect logic and executing the test case;
selecting, based on said error, a second selected NL solution summary of the plurality of NL solution summaries, wherein the second selected NL solution summary can be the first selected NL solution summary;
generating, based on the second selected NL solution summary of the plurality of NL solution summaries, a new linguistic prompt that specifies the plurality of semantic requirements;
inferentially generating, from the new linguistic prompt, by a second scripting LLM that can be the first scripting LLM, a correct logic that can read said data and generate a correct answer; and
executing the correct logic, including reading said data, including generating the correct answer.

2. The method of claim 1 wherein:
said detecting does not comprise said executing the incorrect logic;
said selecting comprises selecting, in response to detecting said error is a syntax error or a build error, the first selected NL solution summary of the plurality of NL solution summaries.

3. The method of claim 2 wherein:
the new linguistic prompt contains the incorrect logic;
the first scripting LLM was not trained to accept a linguistic prompt that contains logic;
said second scripting LLM is a code-correction LLM.

4. The method of claim 1 wherein said selecting comprises:
associating an attempt counter with the first selected NL solution summary of the plurality of NL solution summaries;
selecting, in response to detecting the attempt counter exceeds a threshold, a particular NL solution summary of the plurality of NL solution summaries that is not the first selected NL solution summary of the plurality of NL solution summaries.

5. The method of claim 4 wherein said selecting the particular NL solution summary is based on attempt counter of the particular NL solution summary.

6. The method of claim 1 wherein:
said detecting comprises said executing the test case;
said error is an unsatisfied postcondition of the test case.

7. The method of claim 1 wherein the test case comprises a security guardrail.

8. The method of claim 1 wherein said data is in a data container selected from a group consisting of a database and said NL question.

9. The method of claim 1 wherein said inferentially generating the test case occurs before said inferentially generating the plurality of NL solution summaries.

10. The method of claim 1 further comprising before said detecting the error:
detecting the test case does not detect the error, including executing the test case;
inferentially generating, from the test case and the plurality of semantic requirements, by the prover LLM, a second test case that can detect the error in an answer for the NL question.

11. One or more non-transitory computer-readable media storing instructions that, when executed by one or more processors, cause:
inferentially generating, from a natural language (NL) question about a data, by a problem summarization large language model (LLM), an NL problem summary that specifies a plurality of semantic requirements;
inferentially generating, from the plurality of semantic requirements, by a prover LLM, a test case that can detect an error in an answer for the NL question;
inferentially generating, from the plurality of semantic requirements, by a strategy LLM, a plurality of NL solution summaries, wherein each NL solution summary describes a respective distinct solution of a plurality of mutually-exclusive solutions for the NL question;
inferentially generating, from a first selected NL solution summary of the plurality of NL solution summaries, by a first scripting LLM, an incorrect logic that cannot generate a correct answer;
detecting an error of the incorrect logic, wherein said detecting can comprise executing the incorrect logic and executing the test case;
selecting, based on said error, a second selected NL solution summary of the plurality of NL solution summaries, wherein the second selected NL solution summary can be the first selected NL solution summary;
generating, based on the second selected NL solution summary of the plurality of NL solution summaries, a new linguistic prompt that specifies the plurality of semantic requirements;
inferentially generating, from the new linguistic prompt, by a second scripting LLM that can be the first scripting LLM, a correct logic that can read said data and generate a correct answer; and
executing the correct logic, including reading said data, including generating the correct answer.

12. The one or more non-transitory computer-readable media of claim 11 wherein:
said detecting does not comprise said executing the incorrect logic;
said selecting comprises selecting, in response to detecting said error is a syntax error or a build error, the first selected NL solution summary of the plurality of NL solution summaries.

13. The one or more non-transitory computer-readable media of claim 12 wherein:
the new linguistic prompt contains the incorrect logic;
the first scripting LLM was not trained to accept a linguistic prompt that contains logic;
said second scripting LLM is a code-correction LLM.

14. The one or more non-transitory computer-readable media of claim 11 wherein said selecting comprises:
associating an attempt counter with the first selected NL solution summary of the plurality of NL solution summaries;
selecting, in response to detecting the attempt counter exceeds a threshold, a particular NL solution summary of the plurality of NL solution summaries that is not the first selected NL solution summary of the plurality of NL solution summaries.

15. The one or more non-transitory computer-readable media of claim 14 wherein said selecting the particular NL solution summary is based on attempt counter of the particular NL solution summary.

16. The one or more non-transitory computer-readable media of claim 11 wherein:
said detecting comprises said executing the test case;
said error is an unsatisfied postcondition of the test case.

17. The one or more non-transitory computer-readable media of claim 11 wherein the test case comprises a security guardrail.

18. The one or more non-transitory computer-readable media of claim 11 wherein said data is in a data container selected from a group consisting of a database and said NL question.

19. The one or more non-transitory computer-readable media of claim 11 wherein said inferentially generating the test case occurs before said inferentially generating the plurality of NL solution summaries.

20. The one or more non-transitory computer-readable media of claim 11 wherein the instructions further cause before said detecting the error:
detecting the test case does not detect the error, including executing the test case;
inferentially generating, from the test case and the plurality of semantic requirements, by the prover LLM, a second test case that can detect the error in an answer for the NL question.
